(19) United States
(12) Patent Application Publication
(10) Pub. No.: US 2019/0056223 A1
(43) Pub. Date: Feb. 21, 2019

(54) MEASURING APPARATUS

(71) Applicant: Mitsubishi Electric Corporation, Chiyoda-ku (JP)

(72) Inventor: Ryuichi ISHIHARA, Chiyoda-ku (JP)

(73) Assignee: Mitsubishi Electric Corporation, Chiyoda-ku (JP)

(21) Appl. No.: 16/078,872

(22) PCT Filed: Feb. 8, 2017
(86) PCT No.: PCT/JP2017/004524

§ 371 Date: Aug. 22, 2018

(30) Foreign Application Priority Data
Mar. 22, 2016 (JP) 2016-057105

(51) Int. Cl. G01C 7/04; G01C 11/06; H01Q 1/12; H01Q 1/32; G06T 7/70

(52) U.S. Cl. CPC G01C 7/04; G01C 11/06; G06T 2207/30252; H01Q 1/3275; G06T 7/70; H01Q 1/1207

(57) ABSTRACT

A measuring apparatus (10) is mounted on a movable body and measures a ground object around the movable body. The measuring apparatus (10) includes three receive antennas (15, 16, and 17) that receive signals generated by navigation satellites; and a first measuring apparatus (13 and 14) that measures a ground object around the movable body. Of the three receive antennas (15, 16, and 17), a first antenna (15) and a second antenna (16) are disposed at a predetermined spacing and at the rear of a roof portion of the movable body. A third antenna (17) is disposed at the front of the roof portion of the movable body. According to the measuring apparatus (10), a measuring device can be additionally mounted on the rear of a vehicle.

### TECHNICAL FIELD

The present invention relates to a measuring apparatus that captures an image of a ground object around a traveled road to measure a location.

### BACKGROUND ART

When a ground object around a road is measured, a mobile measuring apparatus may be used that captures an image of an object with a camera and measures a distance to the object using an automobile having various types of sensors mounted thereon. The mobile measuring apparatus includes receivers of a navigation satellite system that receive signals from navigation satellites; cameras that capture an image of an object; and laser scanners that measure a relative position to the object. The mobile measuring apparatus identifies a current location based on the signals received from the navigation satellites, and identifies the location of the object based on the relative position measured by the laser scanners.

A mobile measuring apparatus disclosed in Patent Literature 1 has receivers, cameras, and laser scanners of a navigation satellite system that are mounted on a top provided on a vehicle's roof portion.

### CITATION LIST

### Patent Literature

Patent Literature 1: JP 2012-242317 A

### SUMMARY OF INVENTION

### Technical Problem

However, it is assumed that upon measurement of a ground object (which refers to, for example, the state of a road surface on which the vehicle travels, a traffic light, a sign, a guardrail, a white line, a separation line, a guardrail, a building, a pedestrian road, an intersection, etc.) around a road, users will demand in the future to measure a surrounding environment ranging from the state of a road surface immediately below the vehicle to a long distance, by mounting a higher-density, higher-power laser scanner.

To respond to such a demand, it is desirable that the measuring apparatus be designed in advance such that a new measuring device (a high-density, high-power laser scanner, etc.) is additionally mountable in addition to an already mounted measuring device.

For example, it is desirable that a high-density, high-power type laser scanner be installed at the rear of the vehicle and perform measurement from a road surface immediately below the vehicle to a distant ground object.

This is because when the state of a road surface immediately below the vehicle is measured, measurement accuracy improves more by installing a measuring device at the rear of the vehicle that allows to directly measure immediately below the vehicle due to the absence of shielding objects such as a hood, than by a measuring device at the front of the vehicle that performs measurement in an oblique direction due to the presence of the hood of the vehicle.

As such, it is desirable that the measuring apparatus be designed such that a new measuring device (e.g., a high-density, high-power type laser scanner) is mountable on the rear of the vehicle as a future extended function.

Note that the top illustrated in Patent Literature 1 is heavy in weight and thus removability and portability are poor.

The present invention is made in view of the above description, and an object of the present invention is to provide a measuring apparatus that is light in weight and can allow a measuring device to be additionally mounted on the rear of a vehicle.

### Solution to Problem

A measuring apparatus according to the present invention is mounted on a movable body and measures a ground object around the movable body, and the measuring apparatus includes: three receive antennas to receive signals generated by navigation satellites; and a first measuring apparatus to measure a ground object around the movable body, wherein of the three receive antennas, a first antenna and a second antenna are disposed at a predetermined spacing and at rear of a roof portion of the movable body, and a third antenna is disposed at front of the roof portion of the movable body.

### Advantageous Effects of Invention

According to the measuring apparatus according to the present invention, an advantageous effect of being able to provide a measuring apparatus that is light in weight and can allow a measuring device to be additionally mounted on the rear of a vehicle is provided.

### BRIEF DESCRIPTION OF DRAWINGS

FIG. 1 is a plan view of a measuring apparatus according to a first embodiment of the present invention.

FIG. 2 is a front view of the measuring apparatus according to the first embodiment of the present invention.

FIG. 3 is a left-side view of the measuring apparatus according to the first embodiment of the present invention.

FIG. 4 is a rear view of the measuring apparatus according to the first embodiment of the present invention.

FIG. 5 is a functional block diagram of a control unit of the measuring apparatus according to the first embodiment of the present invention.

FIG. 6 is a diagram illustrating a configuration in which the functions of the control unit of the measuring apparatus according to the first embodiment are implemented by hardware.

FIG. 7 is a side view illustrating the measuring apparatus according to the first embodiment of the present invention that is installed on an automobile (vehicle).

FIG. 8 is a plan view illustrating the measuring apparatus according to the first embodiment of the present invention that is installed on the automobile (vehicle).

FIG. 9 is a plan view of the measuring apparatus according to the first embodiment of the present invention that has, as an optional additional device, a high-density laser scanner mounted on a rear central portion of the automobile (vehicle).

FIG. 10 is a side view of the measuring apparatus according to the first embodiment of the present invention that has, as an optional additional device, the high-density laser scanner mounted on the rear central portion of the automobile (vehicle).

FIG. 11 is a plan view illustrating a measuring apparatus according to a second embodiment of the present invention with no receiving units at two locations at the rear of the automobile (vehicle).

FIG. 12 is a side view illustrating the measuring apparatus according to the second embodiment of the present invention with no receiving units at two locations at the rear of the automobile (vehicle).

FIG. 13 is a diagram of the separated measuring apparatus 10 according to the first embodiment of the present invention.

FIG. 14 is an example of a cross-section of a third arm 17 according to the first embodiment of the present invention.

FIG. 15 is a diagram describing a coupling portion of a sensor mounting unit 11 to the third arm 17 of the measuring apparatus 10 according to the first embodiment of the present invention.

FIG. 16 is a diagram describing a coupling portion of the third arm 17, a first arm 15, and a second arm 16 of the measuring apparatus 10 according to the first embodiment of the present invention.

### DESCRIPTION OF EMBODIMENTS

Measuring apparatuses according to embodiments of the present invention will be described in detail below based on the drawings. Note that the invention is not limited by the embodiments.

### First Embodiment

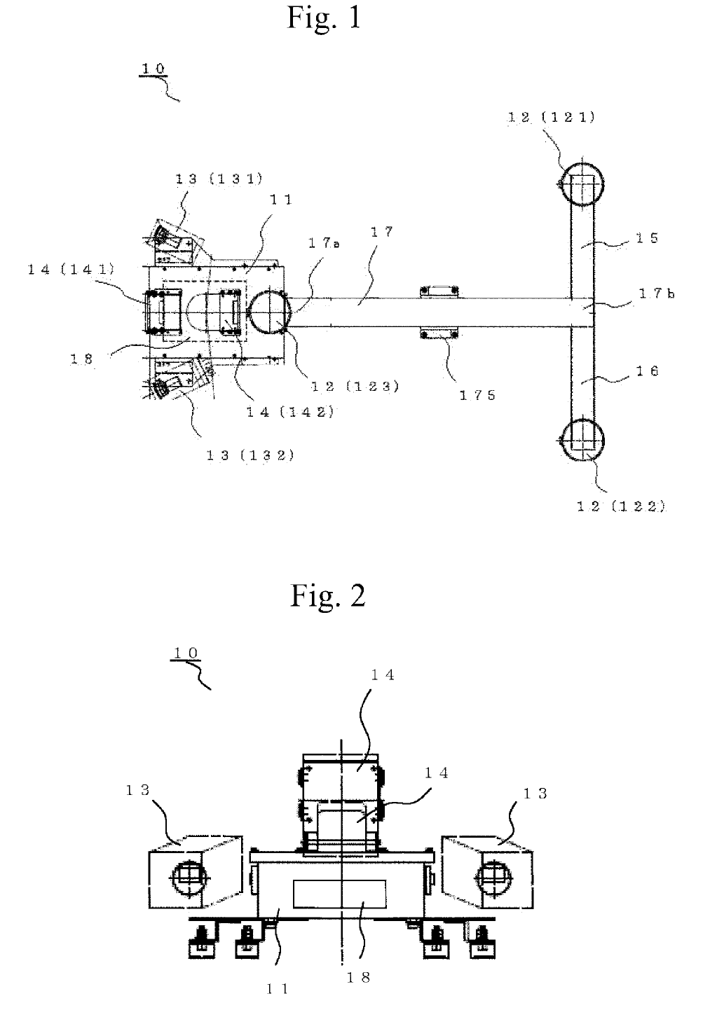

FIG. 1 is a plan view of a measuring apparatus 10 according to a first embodiment of the present invention.

FIG. 2 is a front view of the measuring apparatus 10 according to the first embodiment of the present invention.

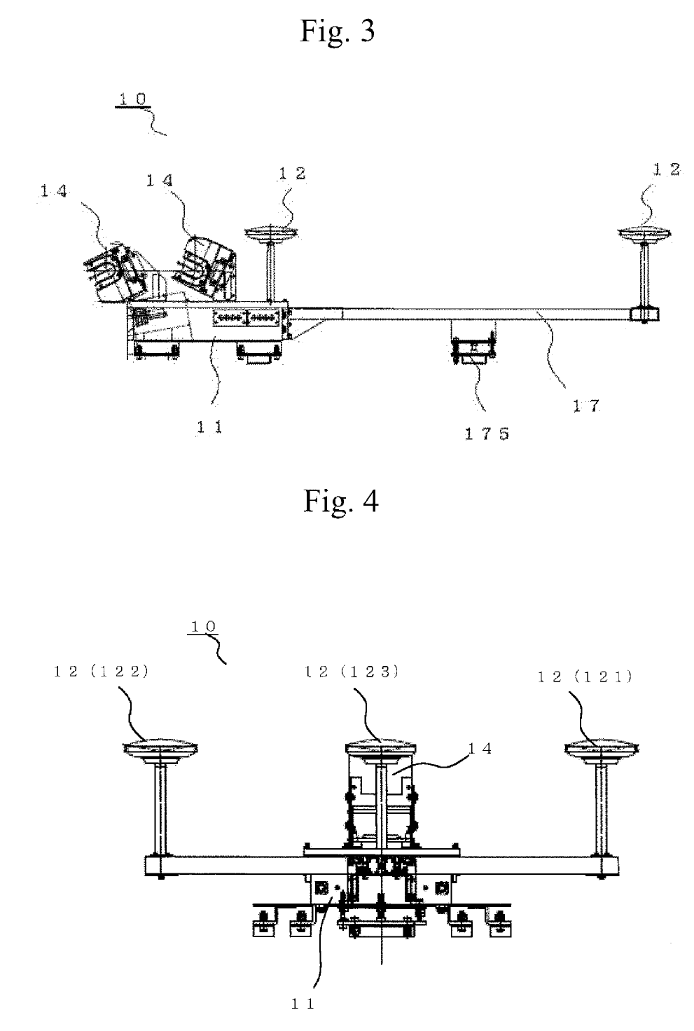

FIG. 3 is a left-side view of the measuring apparatus 10 according to the first embodiment of the present invention.

FIG. 4 is a rear view of the measuring apparatus 10 according to the first embodiment of the present invention.

The measuring apparatus 10 includes a sensor mounting unit 11 that accommodates a control unit 18 which will be described later; receiving units 12 that receive signals generated by navigation satellites; imaging units 13 that capture images of ground objects; and distance measuring units 14 that measure distances to the ground objects.

The receiving units 12 include a first antenna 121, a second antenna 122, and a third antenna 123.

Here, the first antenna 121 and the second antenna 122 can be common, popular-type single-frequency global navigation satellite system (GNSS) antennas, and the third antenna can be a dual-frequency GNSS antenna for precise positioning.

The control unit 18 which will be described later can accurately calculate a vehicle location based on received signals that are received by the third antenna 123 for precise positioning from navigation satellites.

In addition, an attitude angle of a vehicle can be calculated based on the fact that the times taken for signals from navigation satellites to reach the first antenna 121 installed on the rear right side of the vehicle, the second antenna 122 installed on the rear left side of the vehicle, and the third antenna 123 installed at the front center in a left-right direction of the vehicle differ from one another. Here, the longer the spacings between the first antenna 121, the second antenna 122, and the third antenna 123, the more improvement in the accuracy of the attitude angle. Though it depends on the vehicle body dimensions of the vehicle on which the measuring apparatus is mounted, it is desirable that baseline lengths which are spacings between the first antenna 121, the second antenna 122, and the third antenna 123 be spaced apart by at least 1 m or more. Note that if somewhat poor measurement accuracy of the attitude angle is can be tolerated, then needless to say, the baseline lengths may be further reduced.

Note that here the front of the vehicle, the rear of the vehicle, the right side of the vehicle, and the left side of the vehicle are defined with reference to a traveling direction of the vehicle on which the measuring apparatus is mounted.

The sensor mounting unit 11 forms a rectangular parallelepiped box shape, and allows sensors such as the imaging units 13, the distance measuring units 14, and the third antenna 123 which will be described later to be mounted thereon. The third antenna 123 is installed on the vehicle rear side of a central portion of the sensor mounting unit 11.

The sensor mounting unit 11 is a base formed of aluminum, steel, carbon fiber reinforced plastic (CFRP), etc. The base of the sensor mounting unit 11 may be a casing that holds therein electrical devices such as a wiring relaying base to which is connected signal wiring for the first antenna 121, the second antenna 122, the third antenna 123, and the like, and a control device that processes signals from the first antenna 121, the second antenna 122, the third antenna 123, and the like. In addition, the sensor mounting unit 11 may be mounted on a base and cover optical sensors such as the imaging units 13 and the distance measuring units 14 which will be described later. The sensor mounting unit has a hole which is made to prevent optical windows of the optical sensors from being blocked.

Note that the imaging units 13 and the distance measuring units 14 are a first measuring apparatus.

The first antenna 121 is installed on a first arm 15 which is fixed at an end portion 17b of a third arm 17 extending rearward from the sensor mounting unit 11.

The second antenna 122 is installed on a second arm 16 which is likewise fixed at the end portion 17b of the third arm 17.

The first arm 15, the second arm 16, and the third arm 17 are made of a tough material, and are connecting members that allow antennas, etc., to be mounted thereon and fix a relative positional relationship between the antennas.

Note that the first arm 15 and the second arm 16 may be a pre-integral member instead of being different members.

FIG. 16 is a diagram illustrating a state in which the first arm 15 and the second arm 16 are fixed to the end portion 17b of the third arm 17 at a coupling portion. The third arm 17, the first arm 15, and the second arm 16 are mechanically coupled and fixed using, for example, bolts.

In addition, the coupling portion of the each of first arm 15, the second arm 16, and the third arm 17 can be removed from the sensor mounting unit 11 by, for example, removing the above-described bolts.

Namely, each of the first arm 15, the second arm 16, and the third arm 17 is configured to be removable from the sensor mounting unit 11.

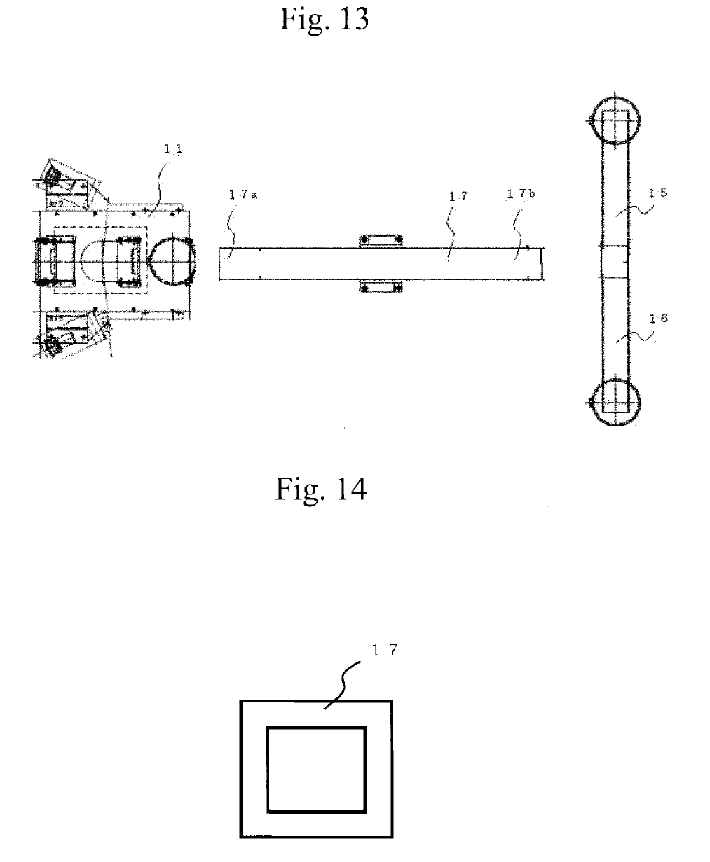

FIG. 13 is a diagram of the measuring apparatus 10 according to the first embodiment that is separated into three parts. The measuring apparatus 10 can be divided into a “sensor mounting unit 11” part, a “third arm 17” part, and a “first arm 15 and second arm 16” part. As described previously, the first arm 15 and the second arm 16 may be an integral member or may be further separable into a “first arm 15” part and a “second arm 16” part.

For comparison, in a conventional measuring apparatus such as that illustrated in, for example, Patent Literature 1, on a top with a hexagonal metal frame body in which a square frame and a pentagonal frame are combined, of three GNSS receivers 110, two GNSS receivers 110b and 110c are installed at the front left and right edges of the top 101 and the remaining one GNSS receiver 110a is installed at the rear center of the top 101, and optical sensors such as imaging units and distance measuring units are mounted. In addition, a casing that holds electrical devices such as a wiring relaying base and a control device is provided separately. Hence, the weight of the top is relatively heavy and thus removal and transport are not easy.

On the other hand, in the measuring apparatus 10 according to the first embodiment, the third antenna 123 and optical sensors such as the imaging units 13 and the distance measuring units 14 are mounted on the sensor mounting unit 11 which forms a casing that holds electrical devices such as a wiring relaying base and a control device. In addition, the first antenna 121 and the second antenna 122 are mounted on the first arm 15, the second arm 16, and the third arm 17 which are different members from the sensor mounting unit 11. In addition, the sensor mounting unit 11, the receiving units 12 that receive signals generated by navigation satellites, the imaging units 13 that capture images of ground objects, and the distance measuring units 14 that measure distances to the ground objects are structured to be coupled by the first arm 15, the second arm 16, and the third arm 17 which are coupling members. Furthermore, the first arm 15, the second arm 16, and the third arm 17 are removably connected to the sensor mounting unit 11, and the first arm 15, the second arm 16, and the third arm 17 are formed of relatively simple structural members. Hence, comparing with the conventional measuring apparatus such as that illustrated in Patent Literature 1, the overall weight of the measuring apparatus 10 can be significantly reduced over the conventional structure in which the sensor mounting unit 11, the receiving units 12, the imaging units 13, the distance measuring units 14, etc., are mounted on the top.

In addition, in the measuring apparatus 10 according to the first embodiment, the sensor mounting unit 11, the first arm 15, the second arm 16, and the third arm 17 can be separated into different parts, and thus, upon transporting the measuring apparatus 10, the measuring apparatus 10 can be carried held in a large trunk case. Hence, transport is significantly facilitated compared to the conventional measuring apparatus such as that illustrated in Patent Literature 1.

The first arm 15 has a cable holding portion provided therein. A cable connected to the first antenna 121 is drawn into the first arm 15 through a cable hole, and pulled out of the first arm 15 through a cable hole, and then connected to the control unit 18 in the sensor mounting unit 11.

The second arm 16 has a symmetrical shape to the first arm 15 and has the same structure as the first arm 15.

As illustrated in FIG. 14, the third arm 17 has a square tube-shaped cross-section. In addition, the first arm 15 and the second arm 16 also likewise have a square tube shape. Note that the cross-section is not limited to a square tube shape and may be cylindrical or may be polygonal.

For example, the first arm 15, the second arm 16, and the third arm 17 may have a rectangular plate shape with a rectangular cross-section or a plate shape with increased flexural rigidity that has, for example, an H-shaped or I-shaped cross-section.

The sensor mounting unit 11 is provided with an antenna holding portion that holds the third antenna 123.

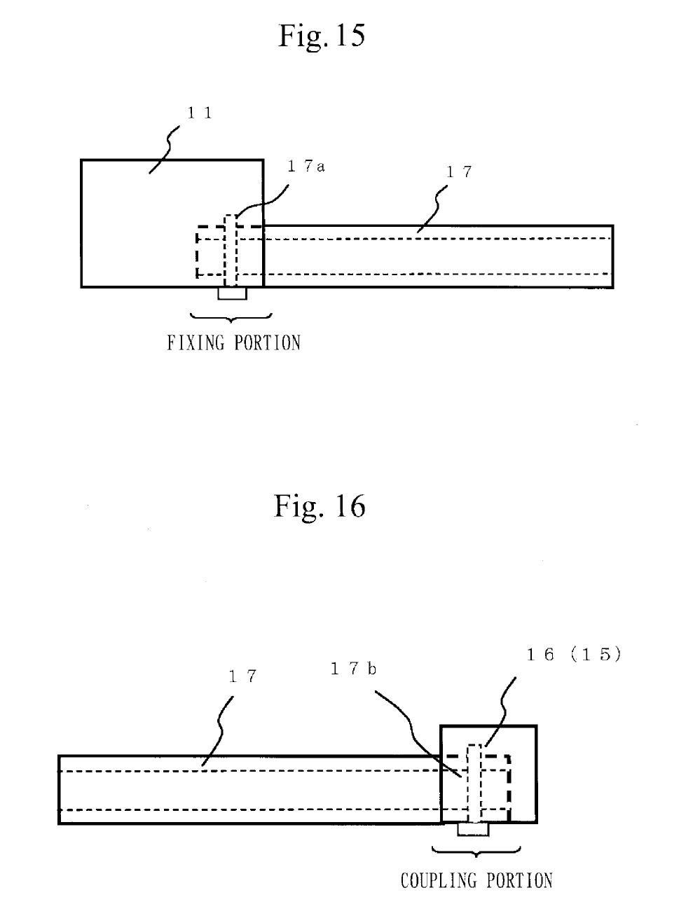

As illustrated in FIG. 15, one end portion 17a of the third arm 17 is provided with a fixing portion which is a margin for mounting the sensor mounting unit 11. At the fixing portion, the one end portion 17a of the third arm 17 and the sensor mounting unit 11 are fixed to each other using a bolt, etc. In addition, by loosening the bolt, etc., at the fixing portion, the sensor mounting unit 11 and the third arm 17 are separated from each other.

The third arm 17 is provided with a cable hole adjacent to the antenna holding portion.

In addition, the third arm 17 includes a vehicle fixing unit 175 which is used upon installation on a movable body (vehicle). Note that examples of the movable body include a vehicle and an automobile.

The imaging units 13 include a first camera unit 131 which is installed on an upper surface of the sensor mounting unit 11 such that the central angle of view is directed to the obliquely forward right and has the angle of depression; and a second camera unit 132 which is installed on the upper surface of the sensor mounting unit 11 such that the central angle of view is directed to the obliquely forward left and has the angle of depression.

The distance measuring units 14 include a first laser scanner 141 which is installed on the upper surface of the sensor mounting unit 11 such that the central axis of a scanning range has the angle of depression; and a second laser scanner 142 which is installed on the upper surface of the sensor mounting unit 11 such that the central axis of a scanning range has the angle of elevation.

The first laser scanner 141 and the second laser scanner 142 measure a time from when laser light is radiated until the laser light is received, and calculate a distance to a ground object by multiplying the measured time by the speed of light.

The front and upper surfaces of the sensor mounting unit 11 are provided with handles. The handles are used upon conveyance and installation of the measuring apparatus 10.

Conventionally, the receivers, cameras, and laser scanners of a navigation satellite system are mounted on a top provided on a vehicle's roof portion, and thus, there is a problem that a movable body measuring apparatus becomes heavy in total weight and also increases in size. For example, when the movable body measuring apparatus is removed from the vehicle's roof portion for device maintenance, a carrying apparatus that handles heavy goods is required, hindering maintenance work.

As such, in the measuring apparatus according to the present embodiment, since the sensor mounting unit 11 that accommodates the control unit 18, the receiving units 12 (the first receive antenna 121, the second receive antenna 122, and the third receive antenna 123) that receive signals generated by navigation satellites, the imaging units 13 that capture images of ground objects, and the distance measuring units 14 that measure distances to the ground objects are fixed only by the three arms (the first arm 15, the second arm 16, and the third arm 17), an advantageous effect of being able to achieve a reduction in weight compared to the conventional measuring apparatus is provided. In addition, since the measuring apparatus can be separated into a plurality of parts as necessary, an advantageous effect of easy transport of the measuring apparatus is also provided.

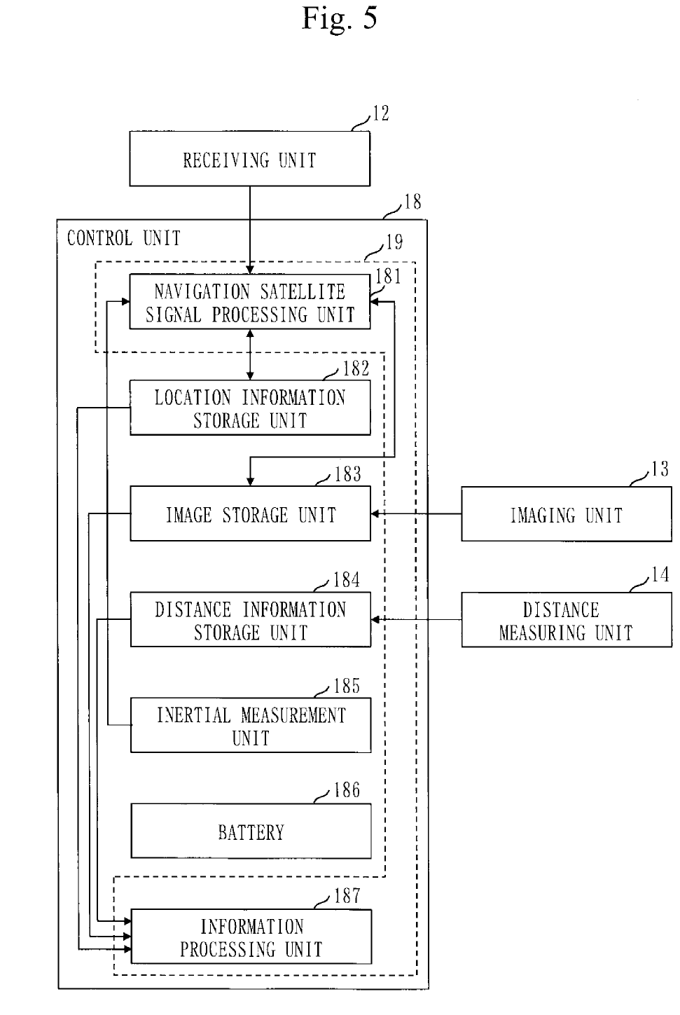

FIG. 5 is a functional block diagram of the control unit 18 of the measuring apparatus 10 according to the first embodiment.

In FIG. 5, the control unit 18 includes a navigation satellite signal processing unit 181 that processes signals from navigation satellites that are received by the receiving units 12, and thereby generates location information; a location information storage unit 182 that stores the location information; an image storage unit 183 that stores images of ground objects photographed by the imaging units 13; and a distance information storage unit 184 that stores information on distances to the ground objects measured by the distance measuring units 14.

In addition, the control unit 18 includes an inertial measurement unit 185 that measures a traveling direction and a traveled distance per unit of time. The location information storage unit 182, the image storage unit 183, and the distance information storage unit 184 are storage units that store information.

In addition, the control unit 18 includes a battery 186 that supplies power to each unit of the measuring apparatus 10. Note that lines indicating the supply of power to each unit from the battery 186 are not illustrated.

In addition, the control unit 18 includes an information processing unit 187 that performs a process of associating location information, an image of a ground object, and distance information with one another. By the information processing unit 187 performing the association process, the locations of feature points in the image can be identified.

For the inertial measurement unit 185, a combination of a gyro sensor that measures angular velocities in triaxial directions and an acceleration sensor that measures accelerations in triaxial directions can be applied.

The navigation satellite signal processing unit 181 calculates a current location based on the signals from the navigation satellites that are received by the receiving units 12 and the traveling direction and traveled distance that are obtained from the inertial measurement unit 185. When the navigation satellite signal processing unit 181 cannot receive signals generated by navigation satellites, the navigation satellite signal processing unit 181 determines a location calculated based on the location information stored in the location information storage unit 182 and the traveling direction and traveled distance that are obtained from the inertial measurement unit 185, to be a current location.

In addition, when the navigation satellite signal processing unit 181 can receive signals generated by navigation satellites, the navigation satellite signal processing unit 181 corrects location information generated based on the signals from the navigation satellites, using a location calculated based on the location information stored in the location information storage unit 182 and the traveling direction and traveled distance that are obtained from the inertial measurement unit 185.

Note that since the times required for signals from navigation satellites to reach the first antenna 121 installed on the rear right side of the vehicle, the second antenna 122 installed on the rear left side of the vehicle, and the third antenna 123 installed at the front center in the left-right direction of the vehicle differ from one another, the navigation satellite signal processing unit 181 can identify the attitude of the measuring apparatus 10 based on the difference between the times at which the first antenna 121, the second antenna 122, and the third antenna 123 receive the signals from the navigation satellites.

Functions of the navigation satellite signal processing unit 181 and the information processing unit 187 are implemented by a processing circuit 19. Namely, the control unit 18 includes a processing circuit that generates location information and the processing circuit 19 that performs a process of associating location information, an image of a ground object, and distance information with one another. In addition, the processing circuit 19 may be dedicated hardware or may be a computing apparatus that executes a program stored in a memory.

When the processing circuit 19 is dedicated hardware, the processing circuit 19 corresponds to a single circuit, a combined circuit, a programmed processor, a parallel programmed processor, an application specific integrated circuit, a field-programmable gate array, or a combination thereof.

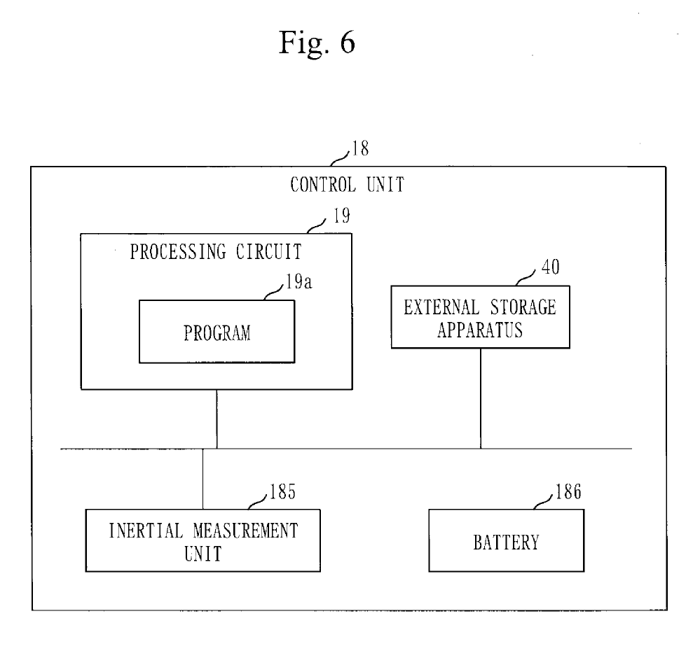

FIG. 6 is a diagram illustrating a configuration in which the functions of the control unit 18 of the measuring apparatus 10 according to the first embodiment are implemented by hardware. Note that lines indicating the supply of power to each unit from the battery 186 are not illustrated.

A program 19a that implements the navigation satellite signal processing unit 181 and the information processing unit 187 is installed in the processing circuit 19 by a logic circuit.

Note that the functions of the navigation satellite signal processing unit 181 and the information processing unit 187 may be implemented by different processing circuits. An external storage apparatus 40 is a storage apparatus that implements the location information storage unit 182, the image storage unit 183, and the distance information storage unit 184. For the external storage apparatus 40, a hard disk drive or a solid-state drive can be applied.

When the processing circuit 19 is a computing apparatus, the functions of the navigation satellite signal processing unit 181 and the information processing unit 187 are implemented by software, firmware, or a combination of software and firmware.

In addition, the program 19a can also be said to be a program that causes a computer to perform procedures and methods for the navigation satellite signal processing unit 181 and the information processing unit 187. The external storage apparatus 40 is a storage apparatus that implements the location information storage unit 182, the image storage unit 183, and the distance information storage unit 184. For the external storage apparatus 40, a hard disk drive or a solid-state drive can be applied.

Note that some of the functions of the navigation satellite signal processing unit 181 and the information processing unit 187 may be implemented by dedicated hardware and some may be implemented by software or firmware. For example, the function of the navigation satellite signal processing unit 181 can be implemented by a processing circuit which is dedicated hardware, and the function of the information processing unit 187 can be implemented by reading and executing, by a processing circuit, a program stored in a memory.

As such, the processing circuit 19 can implement the above-described functions by hardware, software, firmware, or a combination thereof.

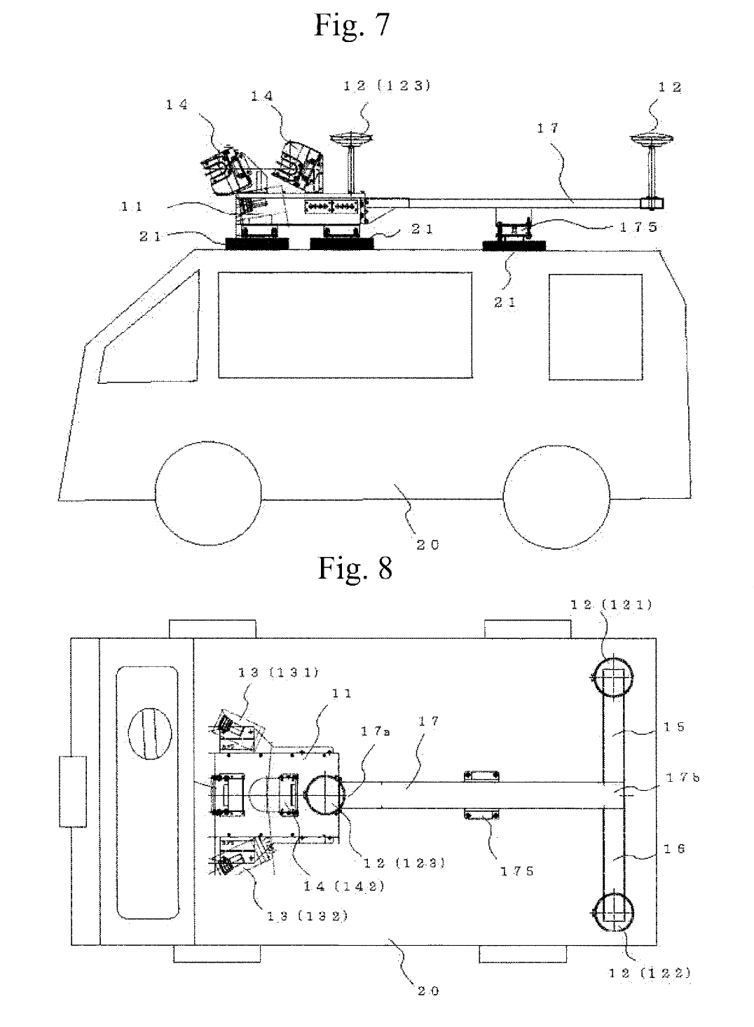

FIGS. 7 and 8 are a side view and a plan view illustrating the measuring apparatus 10 according to the first embodiment that is installed on an automobile 20.

When the measuring apparatus 10 is installed on the automobile 20, the measuring apparatus 10 is disposed such that fixing units for the sensor mounting unit 11 and the vehicle fixing unit 175 of the third arm 17 are located on carriers 21 mounted on the automobile 20, and the fixing units for the sensor mounting unit 11 and the vehicle fixing unit 175 are screwed to the carriers 21.

Note that by disposing collars on the carriers 21 and screwing the fixing units to the carriers 21 with the collars sandwiched between the carriers 21 and the fixing units, the measuring apparatus 10 can be easily installed horizontally.

As such, in the measuring apparatus 10 according to the first embodiment, the first antenna 121, the second antenna 122, and the third antenna 123 which form the receiving units 12 are removable from the sensor mounting unit 11 which is a sensor mounting unit.

By mounting the measuring apparatus 10 on the automobile 20, photographing of ground objects and measurement of locations can be performed on roads on which the automobile 20 can travel.

Next, as an additional function of the measuring apparatus 10 according to the first embodiment, a function of allowing to additionally mount a new measuring device will be described.

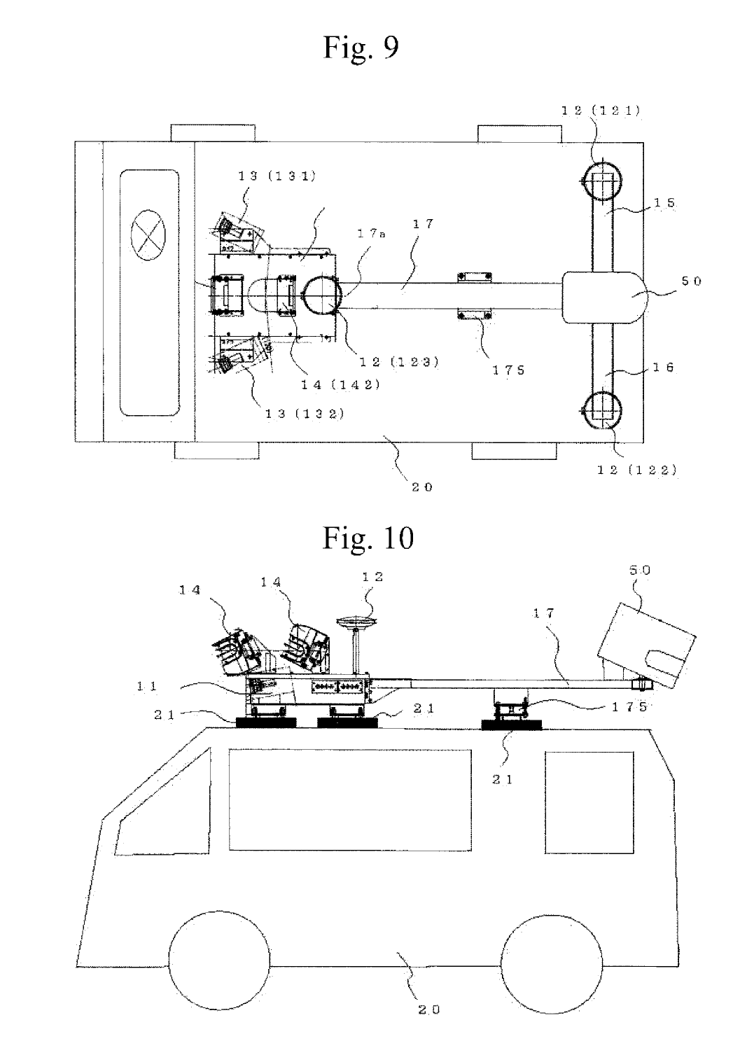

FIG. 9 is a plan view of the measuring apparatus 10 according to the first embodiment that has, as an optional (additional function) new measuring device, a high-density laser scanner 50 (high-density distance measuring unit 50) mounted on a rear central portion in a left-right direction of the automobile (vehicle).

FIG. 10 is a side view of the measuring apparatus according to the first embodiment that has, as an optional new device, the high-density laser scanner 50 (high-density distance measuring unit 50) mounted on the rear central portion in the left-right direction of the automobile (vehicle).

Note that the high-density laser scanner 50 (high-density distance measuring unit 50) is a second measuring apparatus.

In FIGS. 9 and 10, the high-density laser scanner 50 irradiates a road surface with laser light from the rear of the automobile 20 while scanning the laser light, and thereby measures ground objects around a road.

Alternatively, it is also possible that the high-density laser scanner 50 irradiates laser light in the direction of the angle of elevation from a rear position of the automobile 20 while scanning the laser light, and thereby measures ground objects around a road such as buildings and ground objects.

Alternatively, it also becomes possible to measure ground objects around a road such as buildings and ground objects in the distance by orienting a high-power laser scanner in the direction of the angle of elevation from the rear position of the automobile 20.

By thus installing the high-density laser scanner 50 in the rear position of the automobile 20, there is an advantageous effect of enabling measurement of ground objects around a road that cannot be obtained when the high-density laser scanner 50 is installed in a front position of the automobile 20.

In the measuring apparatus 10 according to the present embodiment, as illustrated in FIGS. 9 and 10, the high-density laser scanner 50 which is an optional device is mounted in the position of the end portion 17b which is an end portion on one side of the third arm 17 and which is on the side where the first arm 15 and the second arm 16 are fixed. More specifically, the high-density laser scanner 50 is placed on the third arm 17, the first arm 15, and the second arm 16 and mainly at a location where the third arm 17, the first arm 15, and the second arm 16 cross one another.

As such,

(1) the three receiving units 12, i.e., the first antenna 121, the second antenna 122, and the third antenna 123, are disposed such that one antenna (third antenna 123) is disposed in a front center position of the automobile 20 and two antennas (the first antenna 121 and the second antenna 122) are disposed in the positions of both sides at the rear of the automobile 20, and

(2) the relative positions of the three receiving units 12, i.e., the first antenna 121, the second antenna 122, and the third antenna 123, are fixed by the first arm 15, the second arm 16, and the third arm 17.

By the above-described configurations (1) and (2), when an additional device (e.g., the high-density laser scanner 50) is mounted on the rear position of the automobile 20 as an optional function of the measuring apparatus with the attitude of the measuring apparatus 10 being accurately identifiable, the additional device can be mounted using a portion in which the first arm 15, the second arm 16, and the third arm 17 cross one another.

As such, according to the present embodiment, even when a device is additionally installed on the rear of the automobile 20 as an option, toughness and accuracy can be secured.

Note that when the three receiving units 12 (the first antenna 121, the second antenna 122, and the third antenna 123) are disposed such that two antennas are disposed in the positions of both sides at the front of the automobile 20 and one antenna is disposed in a rear center position of the automobile 20, an additional device (e.g., the high-density laser scanner 50) cannot be mounted on the rear center position of the automobile 20 due to the antenna and thus an optional function cannot be provided.

In addition, when, as disclosed in Patent Literature 1, two antennas, the first antenna 121 and the second antenna 122, are mounted at two locations on the left and right of the sensor mounting unit 11, a range occurs in which the first antenna 121 and the second antenna 122 interfere with the optical axes of the imaging units 13 and the distance measuring units 14 (the angles of view of the first camera unit 131, the second camera unit 132, etc., and the scanning angle of the high-density laser scanner 50).

On the other hand, in the measuring apparatus of the first embodiment, since the third antenna 123 can be installed on the sensor mounting unit 11 and at the front of the vehicle and the first antenna 121 and the second antenna 122 can be disposed at the rear of the vehicle so as to be separated from each other, the range of interference with the optical axes of the imaging units 13 and the distance measuring units 14 can be narrowed, providing better installation flexibility of the imaging units 13 and the distance measuring units 14.

In addition, when, as disclosed in Patent Literature 1, two antennas, the first antenna 121 and the second antenna 122, are mounted at two locations on the left and right of the sensor mounting unit 11, the pole lengths of poles that support the first antenna 121 and the second antenna 122, respectively, need to be set such that the positions of the two antennas, the first antenna 121 and the second antenna 122, are higher than the positions of devices of the imaging units 13 and the distance measuring units 14. This is because if the positions of the first antenna 121 and the second antenna 122 are lower than the positions of the imaging units 13 and the distance measuring units 14, then radio waves from navigation satellites cannot be received because the imaging units 13 and the distance measuring units 14 become shielding objects. Since the heights of the imaging units 13 and the distance measuring units 14 are normally about several tens of centimeters to one meter, the poles that support the first antenna 121 and the second antenna 122, respectively, also need to be set to be higher than or equal to them. However, if the pole length is nearly one meter, then the antenna positions move due to vibration during traveling, causing a degradation in positioning accuracy. In addition, there is also a risk of collision with tree branches, signboards, etc., during traveling, and thus, there are many disadvantages of setting long poles that support the antennas.

On the other hand, in the measuring apparatus of the first embodiment, the third antenna 123 is installed on the sensor mounting unit 11 and at the front of the vehicle and the first antenna 121 and the second antenna 122 are disposed at the rear of the vehicle so as to be separated from each other, and thus, the poles that support the antennas can be set to be relatively short, enabling to minimize the degradation in positioning accuracy caused by the vibration of the poles and the risk of collision with tree branches, signboards, etc.

### Second Embodiment

As a measuring apparatus according to a second embodiment, a mode for a case in which a high-accuracy location is not required upon measuring a location will be described below.

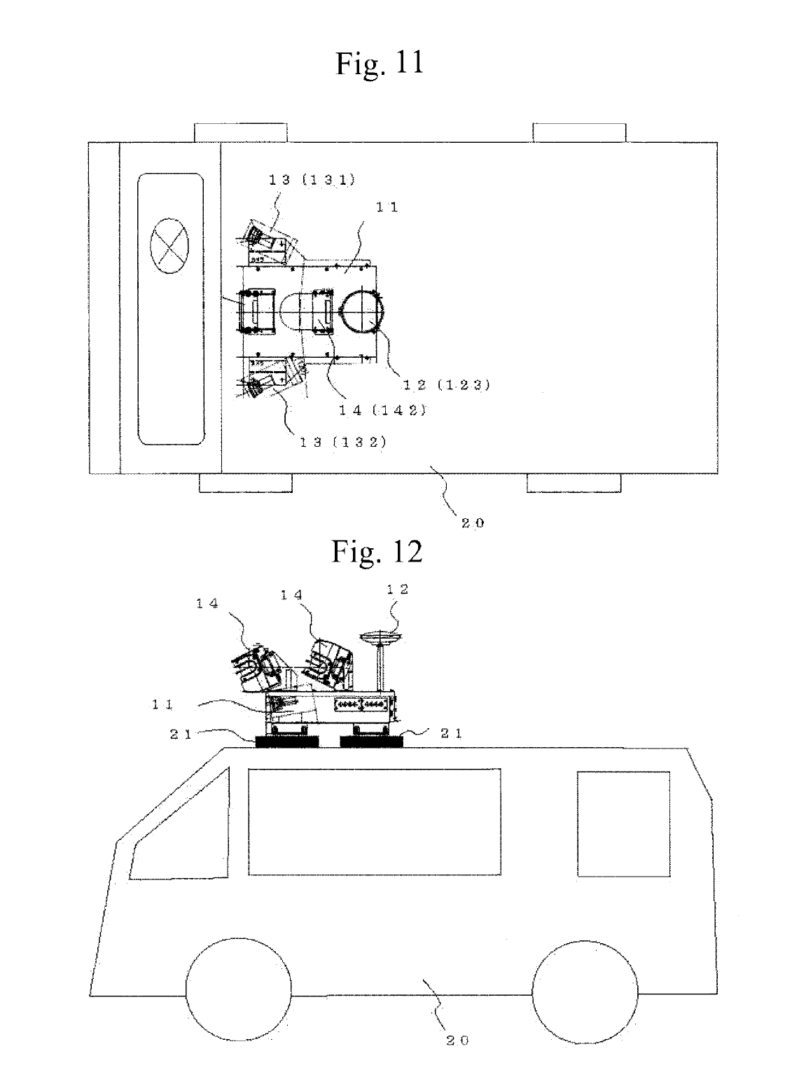

FIG. 11 is a plan view for a case in which a measuring apparatus according to the second embodiment has one antenna that receives signals from navigation satellites.

FIG. 12 is a side view for the case in which the measuring apparatus according to the second embodiment has one antenna that receives signals from navigation satellites.

When there is one antenna that receives signals from navigation satellites, unlike the case of three antennas, the attitude of the measuring apparatus 10 cannot be identified and the accuracy of a measured location also degrades. However, depending on the application, the accuracy of a location measured when there is one antenna may be sufficient.

For such an application, with the configuration of the measuring apparatus having three antennas disposed on the vehicle as described in FIGS. 1 to 6, the apparatus's price is high.

In the measuring apparatus 10 according to the present embodiment, as illustrated in FIGS. 11 and 12, the bolt that couples the third arm 17 to the sensor mounting unit 11 is removed to separate the sensor mounting unit 11, and the first arm 15, the second arm 16, and the third arm 17 into different parts. Then, by mounting only the sensor mounting unit 11 in a predetermined position of the automobile 20, with one antenna 12, ground objects around a road can be measured while the location of the measuring apparatus 10 is measured.

Note that when the three receiving units 12 (the first antenna 121, the second antenna 122, and the third antenna 123) are disposed such that two antennas are disposed in the positions of both sides at the front of the automobile 20 and one antenna is disposed in a rear center position of the automobile 20, even if the bolt that couples the third arm 17 to the sensor mounting unit 11 can be removed, the two antennas remain in the positions of both sides at the front of the automobile 20, and thus, the price of the measuring apparatus 10 is high compared to the case of one antenna.

As such, since one first antenna 121 and one of the receiving units 12 are mounted on the sensor mounting unit 11 and the first arm 15, the second arm 16, and the third arm 17 are different separable parts, the configuration of the measuring apparatus can be modified in various variations, providing ease of use. In addition, comparing with a case in which two antennas, the first antenna 121 and the second antenna 122, are mounted on the sensor mounting unit 11, the configuration of the measuring apparatus is more favorably changed in a variety of ways.

The configurations illustrated in the above-described embodiments illustrate examples of the content of the present invention and can also be combined with other publicly known techniques, and some of the configurations can also be omitted or changed without departing from the spirit of the present invention.

### REFERENCE SIGNS LIST

10: measuring apparatus, 11: sensor mounting unit, 12: receiving unit, 13: imaging unit, 14: distance measuring unit, 15: first arm, 16: second arm, 17: third arm, 17a: end portion on the “sensor mounting unit 11” side of the third arm 17, 17b: end portion, on the side where the first arm 15 and the second arm 16 are fixed, of the third arm 17, 18: control unit, 19: processing circuit, 19a: program, 20: automobile, 21: carrier, 22: collar, 30: carriage, 40: external storage apparatus, 50: high-density distance measuring unit (high-density laser scanner), 121: first antenna, 122: second antenna, 123: third antenna, 131: first camera unit, 132: second camera unit, 141: first laser scanner, 142: second laser scanner, 175: vehicle fixing unit, 181: navigation satellite signal processing unit, 182: location information storage unit, 183: image storage unit, 184: distance information storage unit, 185: inertial measurement unit, 186: battery, 187: information processing unit, 191: computing apparatus, 192: memory, 193: storage apparatus.

1. A measuring apparatus that is mounted on a movable body and measures a ground object around the movable body, the measuring apparatus comprising:
three receive antennas to receive signals generated by navigation satellites; and
a first measuring apparatus to measure a ground object around the movable body, wherein
of the three receive antennas, a first antenna and a second antenna are disposed at a predetermined spacing and at rear of a roof portion of the movable body, and a third antenna is disposed at front of the roof portion of the movable body.

2. The measuring apparatus according to claim 1, wherein
the first antenna is mounted on a first arm,
the second antenna is mounted on a second arm, and
the first antenna and the second antenna are connected to each other through the first arm and the second arm.

3. The measuring apparatus according to claim 2, comprising:
a sensor mounting unit provided with the first measuring apparatus and the third antenna; and
a third arm, wherein
one end of the third arm is fixed to the sensor mounting unit, and
each of the first arm and the second arm is fixed at another end of the third arm so as to be oriented in a substantially perpendicular direction to a longitudinal direction of the third arm.

4. The measuring apparatus according to claim 2, wherein the first arm and the second arm are a same arm.

5. The measuring apparatus according to claim 3, wherein the first arm and the second arm are a same arm.

6. The measuring apparatus according to claim 1, wherein
the first antenna and the second antenna are single-frequency receive antennas capable of receiving only predetermined single-frequency signals generated by navigation satellites, and
the third antenna is a double-frequency receive antenna capable of receiving redetermined double-frequency signals generated by navigation satellites.

7. The measuring apparatus according to claim 2, wherein
the first antenna and the second antenna are single-frequency receive antennas capable of receiving only predetermined single-frequency signals generated by navigation satellites, and
the third antenna is a double-frequency receive antenna capable of receiving predetermined double-frequency signals generated by navigation satellites.

8. The measuring apparatus according to claim 3, wherein
the first antenna and the second antenna are single-frequency receive antennas capable of receiving only predetermined single-frequency signals generated by navigation satellites, and
the third antenna is a double-frequency receive antenna capable of receiving redetermined double-frequency signals generated by navigation satellites.

9. The measuring apparatus according to claim 4, wherein
the first antenna and the second antenna are single-frequency receive antennas capable of receiving only predetermined single-frequency signals generated by navigation satellites, and
the third antenna is a double-frequency receive antenna capable of receiving predetermined double-frequency signals generated by navigation satellites.

10. The measuring apparatus according to claim 5, wherein
the first antenna and the second antenna are single-frequency receive antennas capable of receiving only predetermined single-frequency signals generated by navigation satellites, and
the third antenna is a double-frequency receive antenna capable of receiving predetermined double-frequency signals generated by navigation satellites.

11. The measuring apparatus according to claim 3, further comprising:
a second measuring apparatus to measure a ground object around the movable body, wherein
the second measuring apparatus is mounted on the other end of the third arm and on a fixed location where the first arm and the second arm are fixed to the third arm in the substantially perpendicular direction.

12. The measuring apparatus according to claim 3, wherein
the first arm and the second arm have a same length, and
the first antenna and the second antenna are disposed in line-symmetric positions with the third arm being an axis.

13. The measuring apparatus according to claim 11, wherein
the first arm and the second arm have a same length, and
the first antenna and the second antenna are disposed in line-symmetric positions with the third arm being an axis.

14. A measuring apparatus that is mounted on a movable body and measures a ground object around the movable body as an image or a three-dimensional point group, the measuring apparatus comprising:
receive antennas to receive signals generated by navigation satellites; and
a first measuring apparatus to measure a ground object around the movable body, wherein
the receive antennas include three antennas,
when mobile measurement is performed,
of the three antennas, a first antenna is mounted on a first arm, a second antenna is mounted on a second arm, the first antenna and the second antenna are disposed in positions of both sides at rear of a roof portion of the movable body, respectively, and a third antenna is installed on a sensor mounting unit and disposed in a front center position of the roof portion of the movable body, the first measuring apparatus being mounted on the sensor mounting unit, and
the sensor mounting unit is fixed at one end of the third arm, and each of the first arm and the second arm is coupled at another end of the third arm in a substantially perpendicular direction to a longitudinal direction of the third arm, and
when mobile measurement is not performed,
the first arm, the second arm, the third arm, and the sensor mounting unit are separable.
